(19) United States
(12) Patent Application Publication
(10) Pub. No.: US 2007/0167536 A1
(43) Pub. Date: Jul. 19, 2007

(54) Absorbent member comprising a water absorbing agent

(75) Inventors: Taku Iwamura, Himeji-shi (JP); Yoshiro Mitsukami, Himeji-shi (JP)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company, Cincinnati, OH (US)

(21) Appl. No.: 11/522,197

(22) Filed: Sep. 15, 2006

(30) Foreign Application Priority Data
Sep. 16, 2005 (JP) 2005-270765

(51) Int. Cl. B29C 71/04

(52) U.S. Cl. 522/71

(57) ABSTRACT

The present invention provides an absorbent member for use in absorbent articles, especially for use in diaper or training pants, the absorbent member comprising an absorbing agent which excels in water absorption properties. The absorbing agent is made by a method comprising a) a step of mixing a water absorbing resin, water, and a mixing aid without adding a water-soluble radical polymerization initiator and an ethylenically unsaturated monomer and b) a step of irradiating the resultant mixture with ultraviolet rays while keeping the mixture still agitating the mixture in order to maintain a mixed state.

### FIELD OF THE INVENTION

The present application relates to an absorbent member for use in absorbent articles, for example, diapers and training pants. The present application also relates to a method of making an absorbent member.

### BACKGROUND OF THE INVENTION

Water absorbent resins have been used as one component for hygienic materials such as sanitary cotton, disposable diaper, and absorbents for other kinds of body fluid. Examples of water absorbent resins include hydrolyzate of starch-acrylonitrile graft polymer, neutralized starch-acrylic acid graft polymer, saponified vinyl acetate-acrylic acid ester copolymer, hydrolyzate of acrylonitrile copolymer or acrylamide copolymer, and the product of cross-linkage thereof, and partially neutralized cross-linked acrylic acid may be cited. These water absorbent resins invariably possess an internal cross-linked structure and exhibit no solubility in water.

The characteristic properties which these water absorbent resins are expected to possess may include high absorption capacity against no pressure and against pressure, excellent absorption speed, high gel strength, and fully satisfactory suction force necessary for sucking water from a medium. Since the water absorbing properties are affected by crosslink density, they do not necessarily manifest positive correlations with one another as evinced by the fact that an increase in the crosslink density leads to an increase in the gel strength but a decrease in the amount of water absorbed. For example, the absorption capacity is in a contradictory relation with the absorption speed, the gel strength, and the suction force. The water absorbent resin which has acquired an enhanced absorption capacity may possibly shun uniform absorption of water and forms portions of partial aggregation of itself when the water absorbent resin particles contact with water and induces extreme degradation of the absorption speed because the water is not diffused throughout the entire volumes of water absorbent resin particles.

For the purpose of relaxing this phenomenon and obtaining a water absorbent resin which has a high absorption capacity and a comparatively satisfactory absorption speed, a method for giving the water absorbent resin particles a surface coated with a surfactant or a nonvolatile hydrocarbon has been available. This method exhibits the dispersibility of the initially absorbed water but brings no sufficient effects in enhancing the absorption speed and the suction force of the individual resin particles.

As a means to produce a polyacrylic acid type polymer of high water absorbing property, a method which comprises causing an aqueous composition having a partial alkali metal salt of polyacrylic acid as a main component and having a low crosslink density to be heated in the presence of a water-soluble peroxide radical initiating agent thereby introducing a crosslink therein by radical cross-linkage has been disclosed, for example, by U.S. Pat. No. 4,910,250. It is difficult to distribute uniformly internal cross-links in the polymer and uneasy to adjust the crosslink density. Thus, a measure of preparing a polymer which contains water-soluble polyacrylic acid gel having low crosslink density and then heating the polymer together with a persulfate added thereto as a polymerization initiator is adopted. U.S. Pat. No. 4,910,250 discloses that precise control of crosslink density can be realized by adjusting the amount of the initializing agent to be added and, owing to the uniform presence of crosslink in the polymer, acquire perfect water absorbing properties and obtain as well a water absorbent resin devoid of stickiness.

While the persulfate which is used in U.S. Pat. No. 4,910,250 mentioned above is decomposed by heat, it is decomposed by ultraviolet rays and generates radicals (J. Phys. Chem., 1975, 79, 2693, and J. Photochem. Photobiol., A, 1988, 44, 243). Since the persulfate fulfills a function as a polymerization initiator, the aqueous solution of a water-soluble vinyl monomer, when exposed to radiation, undergoes polymerization and radical cross-linkage simultaneously and produces a hydrogel as disclosed, for example, by JP-A-2004-99789. A reaction system which forms an internal crosslink by adding a hydrophilic polymer component, a photo-polymerization initiator, and a cross-linking agent together and irradiating them with ultraviolet rays has been disclosed, for example, by WO 2004/031253.

Meanwhile, a method which gives a water absorbent resin a surface treatment with a cross-linking agent and imparts thereto a surface of a heightened crosslink density has been also disclosed, for example, by U.S. Pat. No. 4,666,983 and U.S. Pat. No. 5,422,405. Such water absorbent resins as cited in the preceding patent documents entail the presence of a reactive functional group on their surfaces. By effecting introduction of a crosslink between functional groups in consequence of the addition of a surface cross-linking agent capable of reacting with the functional groups, it is made possible to give to the water absorbent resin a surface of increased crosslink density and enable the water absorbent resin to acquire water absorbing properties perfect even under pressure.

Further, since the use of the surface cross-linking agent mentioned above requires the reaction for the formation of cross-links to be performed at a high temperature for a long time and entails the problem of suffering persistence of the cross-linking agent in the unaltered state, a method which, by causing an aqueous solution containing a peroxide radical initiating agent to contact a resin and heating the resin, accomplishes introduction of cross-links into polymer molecular chains in the neighborhood of the surface of the resin by virtue of decomposition of the radical initiating agent has been disclosed, for example, by U.S. Pat. No. 4,783,510. In a working example of this method, a water absorbent resin exhibiting an exalted absorption capacity was obtained by affecting the heating with superheated steam at 130° C. for 6 minutes.

Further, JP-A-2005-97585 discloses a technique for modifying the surface of the water absorbing resin and enhancing the absorbency against pressure by adding a processing liquid containing a radical polymerizing compound and a particulate water absorbing resin and irradiating the resultant mixture with active energy rays. Since this method uses a radical polymerizing compound, however, it has greatly lowered the absorbency against no pressure and entailed a very high cost.

JP-A-63-260907 discloses a technique for decreasing residual monomer content in a water absorbing resin by irradiating a water absorbing resin having specific water content with ultraviolet rays without adding a radical polymerizing compound. However, this technique does not involve the flow of the water absorbing resin during the irradiation with ultraviolet rays, therefore the modification of the surface of the water absorbing resin was performed extremely unevenly, if any.

### SUMMARY OF THE INVENTION

Introducing a surface cross-link to a water absorbing resin consists of producing a water absorbing resin excelling in the balance between absorbency and absorption speed. Generally, a cross-linking agent possessing at least two functional groups capable of reacting with the functional group existing in the surface of a water absorbing resin is required to react with the water absorbing resin. The cross-linking agents which fulfill this requirement include, for example, polyhydric alcohols, polyvalent glycidyl ethers, haloepoxy compounds, polyvalent aldehydes, polyvalent amines, and polyvalent metal salts. Since these cross-linking agents generally are deficient in reactivity, they require the relevant reactions to be performed at elevated temperatures and occasionally placed under application of heat for a long time. Thus, the reactions call for enormous energy and time.

Even in the method for surface treatment disclosed in U.S. Pat. No. 4,783,510, which uses a peroxide radical initiator as a cross-linking agent, the efficient reaction process needs a high temperature and the additional improvement of productivity is also demanded.

The method disclosed in JP-A-2005-97585 suffers a great decrease of the absorbency against no pressure, as well as incurs a high cost owing to the use of a radical polymerizing compound.

Further, the method disclosed in JP-A-1988-260907 is desirable economically in terms that a radical polymerizing compound is not used. However, since the method disclosed in JP-A-1988-260907 does not involve the flow of the water absorbing resin during the irradiation with ultraviolet rays, the modification of a surface of a water absorbing resin is performed extremely unevenly and thus the resultant water absorbing resin has high possibility not to manifest excellent water absorption properties.

In one embodiment, an absorbent member for use in absorbent articles, such as diapers and training pants is provided. In another embodiment, the absorbent member comprises an absorbing agent made by a method for producing a water absorbing agent excelling in such water absorption properties as absorbency and absorbing speed against no pressure or against pressure at a low cost with a high efficiency of production.

The present inventors have made a diligent study in search of a method for producing a water absorbing agent resulting from modifying the surface of a water absorbing resin and have consequently discovered that the uniform modification of the surface of a water absorbing resin can be attained by mixing the water absorbing resin and a water in the presence of a mixing aid and irradiating the resultant mixture with ultraviolet rays while keeping the mixture in a mixed state. This invention has been perfected as a result.

Moreover, the method, whereby the water absorbing agent comprised by the absorbent member of one embodiment is made, enables a modified surface without either using a surface cross-linking agent which has been an essential component for the conventional method or performing a treatment at a high temperature for a long time and permits the production of a target water absorbing agent exhibiting an exalted absorbency against pressure and excelling in such water absorbing properties as absorbency against pressure at a low cost with a high efficiency of production.

It has been simultaneously found that the water absorbing agents repress decrease of the absorbency against no pressure and excels particularly in the balance of water absorbing properties.

Heretofore, the surface cross-linkage which used a reaction by heating has necessitated a treatment at an elevated temperature as in the range of 100 to 300° C., depending on the kind of a surface cross-linking agent to be incorporated. The method whereby the water absorbing agent comprised by the absorbent member of one embodiment is made, permits the surface-modification solely by irradiation with ultraviolet rays and does not always necessitate heat. Furthermore, this method can reduce the energy costs required for the production because this invention can shorten the time of the treatment to a large extent compared with the conventional method.

Since the method, whereby the water absorbing agent comprised by the absorbent member of one embodiment is made, does not use any water-soluble radical polymerization initiator or ethylenically unsaturated monomer which is considered to be activated with ultraviolet rays to induce the formation of surface cross-linkage as well as any surface cross-linking agent reacting by heat, the raw material cost therefor can be decreased.

In respect the material properties, since it does not use any surface cross-linking agent, it can improve only the absorbency of the produced water absorbing agent against pressure considerably without any decrease in the absorbency under no pressure.

Also, the method, whereby the water absorbing agent comprised by the absorbent member of one embodiment is made, can repress the formation of aggregates which are easily occurred at the time of mixing the water absorbing resin and water in the presence of a mixing aid and permit the uniform surface-modification by irradiating the resultant mixture with ultraviolet rays while keeping the mixture in a mixed state.

### BRIEF DESCRIPTION OF THE DRAWINGS

While the specification concludes with claims which particularly point out and distinctly claim the invention, it is believed the various embodiments will be better understood from the following description taken in conjunction with the accompanying drawings, in which:

FIG. 1 is a schematic diagram of a device used for determining the absorbency 0.3 psi against pressure.

FIG. 2 is a schematic cross section of a separable flask made of quartz and used in the working examples.

FIG. 3 (A) is a perspective view of stirring vanes used in the working examples and FIG. 3 (B) is a side view of the stirring vanes used in the working examples.

### DETAILED DESCRIPTION OF THE INVENTION

In one embodiment, an absorbent member for use in absorbent articles, for example, for use in diaper or training pants, comprises an absorbing agent made by a method comprising the steps of:

a) mixing a water absorbing resin, water, and a mixing acid without adding a water-soluble radical polymerization initiator and an ethylenically unsaturated monomer; and

b) irradiating the resultant mixture with an ultraviolet ray while still agitating the mixture in order to maintain a mixed state.

(a) Water Absorbing Resin

In one embodiment, the water absorbing resin is a water-swelling water-insoluble cross-linked polymer capable of forming a hydrogel. As used herein, the term “water absorbing agent” refers to a product resulting from modifying (cross-linking) the surface of a water absorbing resin. The term “water-swelling” as used herein refers to the water absorbency against no pressure in an aqueous 0.9 weight % sodium chloride solution (physiological saline water) such that a given sample absorbs in one embodiment at a ratio of not less than 2 g/g, in another embodiment at a ratio in the range of 5 to 100 g/g, and in yet another embodiment at a ratio in the range of 10 to 60 g/g. The term “water-insoluble” refers to the eluted soluble uncross-linked content (the water-soluble polymer compound) in the water absorbing resin which in one embodiment is in the range of 0 to 50 weight %, in another embodiment not more than 25 weight %, in another embodiment not more than 15 weight %, and in yet another embodiment not more than 10 weight %. The numerical values of the water absorbency against no pressure and the eluted soluble content are those found by the method of determination described in more detail below.

In one embodiment, the absorbent member makes use of a water absorbing resin which possesses a cross-linked structure obtained by polymerizing an acid group-containing unsaturated monomer from the viewpoint of liquid absorbing properties. In one embodiment a monomer such as acrylonitrile which is converted by hydrolysis subsequent to polymerization into an acid group after the polymerization is an acid group-containing unsaturated monomer. In another embodiment, an acid group-containing unsaturated monomer which contains an acid group at the time of polymerization is used.

In one embodiment, the water absorbent resin which can be used, does not need to be particularly restricted but is only required to be capable of being obtained by polymerizing a monomer component essentially containing an ethylenically unsaturated monomer by means of any of the known methods.

The ethylenically unsaturated monomer is not particularly restricted but in one embodiment is a monomer possessing an unsaturated double bond at the terminal thereof. Examples of the monomer according to one embodiment are anionic monomers such as (meth)acrylic acid, 2-(meth)acryloyl ethane sulfonic acid, 2-(meth)acryloyl propane sulfonic acid, 2-(meth)acrylamide-2-methyl propane sulfonic acid, vinyl sulfonic acid, and styrene sulfonic acid and salts thereof; nonionic hydrophilic group-containing monomers such as (meth)acrylamide, N-substituted (meth)acrylamide, 2-hydroxyethyl(meth)acrylate, and 2-hydroxypropyl(meth)acrylate; and amino group-containing unsaturated monomers such as N,N-dimethylaminoethyl(meth)acrylate, N,N-diethylaminoethyl(meth)acrylate, N,N-diethylaminopropyl(meth)acrylate, and N,N-dimethylaminopropyl(meth)acrylamide and quaternized products thereof. These monomers may be used either singly or in the form of a mixture of two or more members. Among monomers enumerated above, (meth)acrylic acid, 2-(meth)acryloyl ethane sulfonic acid, 2-(meth)acrylamide-2-methylpropane sulfonic acid, and salts thereof, N,N-dimethylaminoethyl(meth)acrylate and quaternized In one embodiment, N,N-dimethylaminoethyl(meth)acrylate, and (meth)acrylamide are used as the monomer and in another embodiment, acrylic acid and/or a salt thereof are used as the monomer.

When an acrylic acid salt is used as the monomer, the monovalent salt of acrylic acid selected from the group consisting of alkali metal salts, ammonium salt, and amine salt of acrylic acid proves favorable from the viewpoint of the ability of the water absorbent resin to absorb water. In another embodiment, the alkali metal salt of acrylic acid, for example, the acrylic acid salt selected from the group consisting of sodium salt, lithium salt, and potassium salt is used.

In the production of the water absorbent resin, other monomer components than the monomers enumerated above may also be used. Examples of such other monomer components are hydrophobic monomers such as aromatic ethylenically unsaturated monomers having carbon numbers in the range of 8 to 30, aliphatic ethylenically unsaturated monomers having carbon numbers in the range of 2 to 20, alicyclic ethylenically unsaturated monomers having carbon numbers in the range of 5 to 15, and alkyl esters of (meth)acrylic acid containing alkyl groups having carbon numbers in the range of 4 to 50. The proportion of such a hydrophobic monomer is generally in the range of from about 0 to about 20 weight parts based on 100 weight parts of the ethylenically unsaturated monomer mentioned above. If the proportion of the hydrophobic monomer exceeds about 20 weight parts, this will possibly degrade the water absorbing property of the produced water absorbent resin.

In one embodiment, the water absorbent resin which is used is insolubilized by the formation of an internal crosslink. This internal crosslink may be the product obtained by the self-cross-linkage using no cross-linking agent. It may be formed by using an internal cross-linking agent possessing not less than two polymerizable unsaturated groups and/or not less than two reactive functional groups in the molecular unit.

The internal cross-linking agent of this description does not need to be particularly restricted. Examples of the inner cross-linking agent are N,N′-methylenebis(meth)acrylamide, N-methylol(meth)acrylamide, glycidyl(meth)acrylate, (poly)ethylene glycol di(meth)acrylate, (poly)propylene glycol di(meth)acrylate, glycerin tri(meth)acrylate, glycerin acrylate methacrylate, polyvalent metal salts of (meth)acrylic acid, trimethylol propane tri(meth)acrylate, triallyl amine, triallyl cyanurate, triallyl isocyanurate, triallyl phosphate, ethylene glycol diglycidyl ether, (poly)glycerol glycidyl ether, and polyethylene glycol diglycidyl ether. These internal crosslinking agents may be used in the form of a mixture of two or more members.

In one embodiment, the amount of the internal cross-linking agent to be used is in the range of from about 0.0001 to about 1 mol %, in another embodiment in the range of from about 0.001 to about 0.5 mol %, and in yet another embodiment in the range of from about 0.005 to about 0.2 mol %. If this amount is below about 0.0001 mol %, this will possibly prevent the internal cross-linking agent from being introduced into the resin. Conversely, if the amount exceeds about 1 mol %, this will possibly unduly heighten the gel strength of the water absorbent resin and lower the absorption capacity. For the introduction of the cross-linked structure into the interior of the polymer by the use of the internal cross-linking agent, it suffices to add the internal cross-linking agent into the reaction system before, during, or after the polymerization of the monomer or after neutralization of the produced polymer.

For the purpose of producing the water absorbent resin, it suffices to polymerize the monomer components including the monomer mentioned above and the internal cross-linking agent in an aqueous solution thereof. Examples of the polymerization initiators which can be used are water-soluble radical polymerization initiators including persulfates such as potassium persulfate, ammonium persulfate, and sodium persulfate; potassium peracetate, sodium peracetate, potassium percarbonate, sodium percarbonate, and t-butyl hydroperoxide; hydrogen peroxide; azo compounds such as 2,2′-azobis(2-amidinopropane)-dihydrochloride and photopolymerization initiators including 2-hydroxy-2-methyl-1phenyl-propan-1-on. The water-soluble radical polymerization initiators mentioned above may be combined with a reducing agent such as a sulfite, L-ascorbic acid, or a ferric salt so as to be used as redox type initiators.

The concentration of the monomer in the aqueous monomer solution mentioned above does not need to be particularly restricted but falls in the range of from about 15 to about 90 wt. % and in another embodiment in the range of from about 35 to about 80 wt. %. If this concentration is below about 15 wt. %, this may be disadvantageous with regard to heat consumption and with regard to the time required for drying because the resultant hydrogel may have an unduly large water content.

The method to be adopted for the polymerization is not particularly restricted but may be selected from among the known methods such as solution polymerization, reversed-phase suspension polymerization, precipitation polymerization, and bulk polymerization. Among these methods, the aqueous solution polymerization which comprises dissolving a monomer in an aqueous solution and polymerizing it in the aqueous solution, and the reversed phase suspension polymerization prove particularly advantageous on account of the ease of control of a polymerization reaction and the performance of a produced water absorbent resin.

In initiating the aforementioned polymerization, the polymerization initiator mentioned above is used to effect this initiation. Besides the polymerization initiator mentioned above, active energy rays as ultraviolet rays, electron radiation, and γ rays may be used either singly or in combination with a polymerization initiator. Though the temperature in initiating the polymerization depends on the kind of polymerization initiator to be used, it falls in the range of from about 15 to about 130° C. and in another embodiment in the range of from about 20 to about 120° C. If the temperature in initiating the polymerization deviates from the range mentioned above, this may be disadvantageous with regard to increased residual monomer in the produced water absorbent resin and the self cross-linking reaction may proceed too long, consequently degrading the water absorbing property of the water absorbent resin.

The term “reversed phase suspension polymerization” refers to a method of polymerization performed on an aqueous monomer solution suspended in a hydrophobic organic solvent. It is disclosed in U.S. Pat. Nos. 4,093,776; 4,367,323; 4,446,261; 4,683,274; and 5,244,735, for example. The term “aqueous solution polymerization” refers to a method for polymerizing an aqueous monomer solution without using a dispersing solvent. It is disclosed in U.S. Pat. Nos. 4,625,001; 4,873,299; 4,286,082; 4,973,632; 4,985,518; 5,124,416; 5,250,640; 5,264,495; 5,145,906; and 5,380,808 and European Patent Nos. 0811636; 0955086; and 0922717, for example. The monomers and the initiators which are cited by way of illustration in these methods of polymerization can be applied to embodiments disclosed herein.

The aqueous solution polymerization can be implemented by polymerizing a partially neutralized acrylic acid or polymerizing an acid group-containing monomer such as, for example, acrylic acid and thereafter neutralizing the resultant polymer with an alkali compound such as sodium hydroxide, ammonium hydroxide, sodium carbonate, or ammonium carbonate.

In one embodiment, the neutralization degree of the produced water absorbing resin containing an acid group (the mol % of the neutralized acid group in the whole acid group) is in the range of not less than about 50 mol % and less than about 95 mol %, in another embodiment in the range of from about 53 to about 85 mol %, in another embodiment in the range of from about 55 to about 75 mol %, and in yet another embodiment in the range of from about 60 to about 65 mol %. If the aforementioned neutralization degree is below about 50 mol %, this will possibly lower the water absorbency of the water absorbing resin. If it exceeds about 95 mol %, this will possibly inhibit or even prevent the surface treatment from proceeding.

After polymerization, generally the cross-linked polymer is in the form of a hydrogel. While one embodiment allows this hydrogel-like cross-linked polymer to be unaltered in order to form the water absorbing resin, in another embodiment the polymer can be dried until a water content (%) (100—solid content (%)) is achieved, which will be specifically described below.

In one embodiment, the water absorbent resin which is used is a powdery water absorbent resin which is obtained by polymerizing a monomer having acrylic acid (salt) particularly as its main component. The hydrogel-like cross-linked polymer which is obtained by polymerization is dried and subsequently pulverized to a particulate water absorbent resin. The drying may be effected by using a drier such as a hot air drier at a temperature in the range of from about 100 to about 220° C. and in another embodiment in the range of from about 120 to about 200° C.

For use in the pulverization, among shear primary crushers, impact shredders, and high speed rotary grinders included in the powdering machines classified in Table 1.10 of the Particle Technology Handbook (first edition, compiled by Particle Technology Association), the powdering machines which possess at least one of the powdering mechanisms such as cutting, shearing, striking, and rubbing can be adopted. In one embodiment, the powdering machines which have cutting and shearing as main mechanisms can be used. In another embodiment, a roll mill (roll rotary type) powdering machine may be used.

In one embodiment, the water absorbing resin to be used is in a powdered form. In one example, it is a powdered water absorbing resin which contains particles of diameters of not less than about 150 μm and less than about 850 μm (as defined by sieve classification) at a ratio in the range of from about 90 weight % to about 100 weight %, in another embodiment in the range of from about 93 weight % to about 100 weight %, in another embodiment in the range of from about 95 weight % to about 100 weight %, in another embodiment in the range of from about 98 weight % to about 100 weight %, and in yet another embodiment in the range of from about 99 weight % to about 100 weight %.

When the aforementioned powdered water absorbing resin happens to have mainly particles of at least about 850 μm in diameter and the water absorbing agent manufactured from this resin is used in a disposable diaper, the disposable diaper may give an unpleasant touch to the skin and may possibly rupture the topsheet of the diaper. Also, the water absorption speed may be reduced. Using mainly particles of less than about 150 μm in diameter, the resin powder may aggregate upon exposure to water, and may also fail to undergo uniform irradiation with the active energy rays. Further, this may allow low or even no enhancement of water absorption capacity against pressure. When the resin having a particle size of less than about 150 μm is used in a disposable diaper, for example, of the particles may pass through the topsheet of the diaper onto the outer surface of the diaper.

In one embodiment, the weight average particle diameter (D50) of the water absorbing resin is not less than about 300 μm and less than about 500 μm, in another embodiment in the range of from about 300 to about 450 μm, and in yet another embodiment in the range of from about 300 to about 400 μm.

In one embodiment, the logarithmic standard deviation of particle size distribution (σζ) of the water absorbing resin is in the range of from about 0.20 to about 0.45, in another embodiment in the range of from about 0.20 to 0.40, in another embodiment in the range of from about 0.20 to about 0.35, and in yet another embodiment in the range of from about 0.20 to about 0.30. The logarithmic standard deviation of particle size distribution (σζ) means a magnitude which decreases with decreasing particle size distribution. For the water absorbing resin of one embodiment, it is desirable to have a particle size distribution which is not simply narrow but is widened to a certain extent. If the logarithmic standard deviation of particle size distribution (σζ) of the aforementioned water absorbing resin exceeds about 0.45, this will possibly have a negative impact on the water absorbency against pressure because of an unduly wide particle size distribution. If it is below about 0.20, this will possibly conspicuously lower the productivity of the water absorbing resin.

Incidentally, the weight average particle diameter of the water absorbing resin (D50) and the logarithmic standard deviation of particle size distribution (σζ) of the water absorbing resin are the magnitudes which are determined by the method specified in the working example which will be cited herein below.

In one embodiment, the water absorbing resin to be used has an eluted soluble content which is not less than about 0.1 weight parts and less than about 30 weight parts, in another embodiment in the range of from about 1 to about 25 weight parts, in another embodiment in the range of from about 3 to about 20 weight parts, and in yet another embodiment in the range of from about 5 to about 15 weight parts per 100 weight parts of the aforementioned water absorbing resin. If the eluted soluble content of the water absorbing resin is below about 0.1 weight parts, this will possibly necessitate a large amount of an inner cross-linking agent during the course of polymerization, heighten the cost, and further lower the water absorbency. Conversely, if the eluted soluble content of the water absorbing resin exceeds about 30 weight parts, this will possibly induce liquidation of a soluble component during the addition of water or an aqueous solution, inhibiting the soluble component from functioning as a binder between the adjacent water absorbing resin particles. Also, this may give rise to lumps of powder, prevent the surface treatment from proceeding uniformly, and also prevent the water absorbency against pressure from being sufficiently exalted.

In one embodiment, the water absorbing resin to be used may also be obtained by preparing a precursor water absorbing resin having a relatively low neutralization degree and then mixing the precursor water absorbing resin with a base. Heretofore, polyfunctional surface treating agents have been used for the surface treatment (surface cross-linking treatment). These polyfunctional surface treating agents can react with the carboxyl groups (—COOH) in the water absorbing resin but fail to react with the salt thereof (such as, for example, —COONa). Thus, by polymerizing an ethylenically unsaturated monomer mixture (the mixture of acrylic acid and sodium acrylate, for example) adjusted in advance so as to have a suitable —COOH/—COONa ratio in order to produce a water absorbing resin having —COOH and —COONa distributed uniformly therein, and using the produced water absorbing resin for the surface treatment with polyfunctional surface treating agents, it is possible to obtain uniform cross-linkage. A water absorbing resin may be obtained by polymerizing an acid type ethylenically unsaturated monomer as acrylic acid such as, for example, a main component and then the resultant polymer is neutralized with an alkali compound such as, for example, sodium hydroxide or sodium carbonate. If this water absorbing resin is surface cross-linked with polyfunctional surface treating agents, the cross-linkage is indeed at an advantage in yielding a small eluted soluble content of the water absorbing resin. Nevertheless, this cross-linkage inevitably results in a decrease of the water absorption property because —COOH and —COONa are not uniformly distributed. Thus, it has not been advisable to subject the water absorbing resin obtained by the latter method to the conventional surface cross-linkage with the polyfunctional surface treating agents. According to the method of making the water absorbing agent comprised by the absorbent member, it is possible to modify a water absorbing resin obtained by polymerizing a monomer/monomer mixture having as main component such an acid type ethylenically unsaturated monomer as acrylic acid, thereby obtaining a precursor water absorbing resin having a low neutralizing degree. Thus precursor water absorbing resin is neutralized with an alkali compound such as sodium hydroxide or sodium carbonate, whereby a water absorbing resin is obtained which has —COOH and —COONa distributed uniformly thereon. The water absorbing agent which is obtained by this method can manifest excellent water absorption properties.

A precursor water absorbing resin having a low neutralization degree as used herein refers to a precursor water absorbing resin having a neutralization degree (the mol % of the neutralized acid group in all the acid groups) in the range of from about 0 to about 50 mol % and in another embodiment in the approximate range of from about 0 to about 25 mol %. The precursor water absorbing resin having such a low neutralization degree can be obtained by following the aforementioned method while using a monomer mixture including such an acid group-containing monomer such as acrylic acid in such a manner as to acquire the aforementioned neutralizing degree. Thus, the detailed explanation of the precursor will be omitted here.

In one embodiment, the water content of the water absorbing resin to be used for the method of producing a water absorbing agent does not need to be particularly restricted so long as the water absorbing resin possesses fluidity. The water content of the water absorbing resin after being dried at 180° C. for three hours is in the range of from about 0 to about 20 weight %, in another embodiment in the range of from about 0 to about 10 weight %, and in another embodiment in the range of from about 0 to about 5 weight %. Incidentally, the water content of the water absorbing resin is the magnitude determined by the method specified in the working example which will be cited herein below.

Further, in the method of one embodiment, during the course of mixing of the water absorbing resin and water mentioned above, other additives may be additionally used with the objective to impart other functions to the water absorbing agent unless they exert such adverse effects as deterioration on the water absorbing resin obtained in consequence of the radiation of the ultraviolet rays. Anti-fungus agents, aromatic agents, deodorants, etc. may be cited as concrete examples of the additives mentioned above.

(b) Mixture of Water Absorbing Resin, Water, and Mixing Aid

In the method of making the water absorbent agent comprised by the absorbent member, the water-soluble radical polymerization initiator and the ethylenically unsaturated monomer are not added at the time of mixing the water absorbing resin, water, and the mixing aid. Therefore, the method does not include the case of adding only the water-soluble radical polymerization initiator or adding only the ethylenically unsaturated monomer at the time of mixing the water absorbing resin, water.

As regards the mixing ratio of the aforementioned water absorbing resin and water, water is added in an amount of not less than about 1 weight part and less than about 50 weight parts, in another embodiment in the range of from about 2 to about 30 weight parts, in another embodiment in the range of from about 3 to about 15 weight parts, in another embodiment in the range of from about 4 to about 13 weight parts, and in yet another embodiment in the range of from about 5 to about 10 weight parts, based on 100 weight parts of the water absorbing resin. If the amount of water is below about 1 weight part, this will possibly prevent radiation with ultraviolet rays from inducing surface cross-linkage as expected. If it is not less than about 50 weight parts, this will possibly lower the water absorbency against no pressure and against pressure of the produced water absorbing resin.

In one embodiment, the mixing aid is not particularly limited, so long as that it should be a water-soluble or water-dispersible compound except an ethylenically unsaturated monomer or a water-soluble radical polymerization initiator, and as long as it can repress the agglomeration of the water absorbent resin with water and improve the mixing of the aqueous solution with the water absorbent resin. Since the addition of the mixing aid can repress the agglomeration of the water absorbent resin with water, and induce the uniform mixing of the aqueous solution with the water absorbent resin, the ultraviolet rays, when irradiation is done in the subsequent step, can equally and evenly irradiate the water absorbent resin and thus the uniform surface cross-linkage of the entire water absorbent resin can be achieved. To be specific, a surfactant, a water-soluble polymer compound, a hydrophilic organic solvent, a water-soluble inorganic compound, an inorganic acid, an organic acid, and an organic salt are available. As used herein, the term “water-soluble compound” means a compound having solubility in 100 g of water at room temperature of not less than about 1 g, preferably not less than about 10 g.

When the mixing aid is used, the mode of using the mixing aid is not particularly restricted. Though the mixing aid may be used in the form of powder or be dissolved, dispersed, or suspended in a solution, in one example it is used in the form of an aqueous solution. Incidentally, the aqueous solution may incorporate other solvents than water within the range in which the solubility of the mixing aid is not impaired.

When the mixing aid is used, the point of time for adding the mixing aid is not particularly restricted. The mixing aid may either be added before adding the water absorbing resin and water thereto, subsequently mixing them altogether or the mixing aid may be added simultaneously with the water absorbing resin, water.

In one embodiment, the aqueous solution containing the mixing aid has a surface tension in the range of from about 40 to about 75 dynes/cm, in another embodiment in the range of from about 45 to about 70 dyes/cm, in another embodiment in the range of 48 to 65 dynes/cm, and in yet another embodiment in the range of from about 50 to about 60 dynes/cm. If the surface tension is below about 40 dynes/cm, this will possibly lower the capillary capacity of the water absorbing resin during the course of absorbing water and, when the resin is used as in a disposable diaper, increase the amount of the absorbed liquid remaining on or flowing back onto on the topsheet of the diaper. If the surface tension exceeds about 75 dynes/cm, this will possibly disrupt the uniformity of the mixture of the water absorbing resin and the aqueous solution and prevent the ultraviolet rays from radiating uniformly. The surface tension of the aqueous solution containing the aforementioned mixing aid is the magnitude which is determined by the method specified in the working example cited herein below.

Regarding the surfactant used as the mixing aid, at least one surfactant selected from the group consisting of nonionic surfactants and anionic surfactants having an HLB of not less than 7 can be used. Specific examples of the surfactant are sorbitan fatty acid esters, polyoxyethylene sorbitan fatty acid esters, polyglycerin fatty acid esters, polyoxyethylene alkyl ethers, polyoxyethylene alkyl phenol ethers, polyoxyethylene acyl esters, sucrose fatty acid esters, higher alcohol sulfuric acid esters, alkyl naphthalene sulfonic acid salts, alkyl polyoxyethylene sulfate salts, and dialkyl sulfosuccinic acid salts. Polyoxyethylene alkyl ethers are particularly advantageous as surfactants. The molecular weight of the polyoxyethylene alkyl ether is from about 200 to about 100,000 and in another embodiment from about 500 to about 10,000. If the molecular weight is unduly large, this may lower the solubility of the surfactant in water, allowing no addition of the amount to be added, increase the viscosity of the solution, and impair the mixing property of the surfactant with the water absorbing resin. Conversely, if the molecular weight is unduly small, this may degrade the effect as a mixing aid.

Examples of the water-soluble polymer compound, macromolecules possessing solubility of not less than about 1 wt. % in water at room temperature may be cited, for example, polyvinyl alcohol, polyethylene oxide, polyethylene glycol, polypropylene glycol, polyacryl amide, polyacrylic acid, sodium polyacrylate, polyethylene imine, methyl cellulose, carboxymethyl cellulose, hydroxy-ethyl cellulose, hydroxypropyl cellulose, dextrin, sodium alginate, and starch. In one embodiment, polyethylene glycol proves particularly advantageous as water-soluble polymer compound. In one embodiment, the molecular weight of the compound is from about 200 to about 100,000 and in another embodiment from about 500 to about 10,000, similarly to the polyoxyethylene alkyl ether.

Examples of the hydrophilic organic solvent are alcohols such as methyl alcohol, ethyl alcohol, propyl alcohol, isopropyl alcohol, butyl alcohol, isobutyl alcohol, and t-butyl alcohol; ketones such as methylethyl ketone; ethers such as dioxane, alkoxy(poly)ethylene glycol, and tetrahydrofuran; amides such as g-caprolactam and N,N-dimethyl formamide; sulfoxides such as dimethyl sulfoxide; and polyhydric alcohols such as ethylene glycol, diethylene glycol, propylene glycol, triethylene glycol, tetraethylene glycol, 1,3-propane diol, dipropylene glycol, 2,2,4-trimethyl-1,3-pentadiol, glycerin, 2-butene-1,4-diol, 1,3-butane diol, 1,4-butane diol, 1,5-pentane diol, 1,6-hexane diol, 1,4-cyclohexane dimethanol, 1,2-cyclo-hexenol, trimethylol propane, diethanol amine, triethanol amine, polyoxypropylene, pentaerythritol, and sorbitol. These solvents may be used either singly or in the form of a mixture of two or more members.

Examples of the water-soluble inorganic compound, inorganic compounds possessing solubility of not less than about 5 wt. % in water may be cited, for example, water-soluble metal salts which are salts of metals having valences of at least one. Examples of the water-soluble metal salt are alkali metal salts such as sodium chloride, sodium hydrogen sulfate, and sodium sulfate, ammonium salts such as ammonium chloride, ammonium hydrogen sulfate, and ammonium sulfate, alkali metal hydroxides such as sodium hydroxide and potassium hydroxide, polyvalent metal salts such as aluminum chloride, aluminum polychloride, aluminum sulfate, potassium alum, calcium chloride, calcium sulfate, calcium carbonate, magnesium chloride, magnesium sulfate, magnesium carbonate, zirconium sulfate, zirconium nitrate, zirconium acetate, zirconium carbonate, zirconium ammonium acetate, zirconium ammonium carbonate, zirconium oxychloride, zirconium chloride, titanium chloride, and titanium sulfate, and irreducible alkali metal salt pH buffer agents such as hydrogen carbonates, dihydrogen phosphates, and hydrogen phosphates.

Typical examples for inorganic acids salts are the salts of the inorganic acid selected from the group consisting of hydrochloride acid, sulfuric acid, phosphoric acid, carbonic acid, and boric acid may be cited such as alkali metal salts and alkaline earth metal salts. Examples for organic acids salts, the salts of the organic acids selected from the group consisting of acetic acid, propionic acid, lactic acid, citric acid, succinic acid, malic acid, and tartaric acid, such as alkali metal salts and alkaline earth metal salts.

Among other compounds enumerated above, polyoxyethylene alkyl ethers, polyethylene glycol, and water-soluble metal salts are advantageously usable as a mixing aid.

When a macromolecular mixing aid such as a polyoxyethylene alkyl ether or polyethylene glycol is used, the number average molecular weight (Mn) of this mixing aid is from about 100 to about 500000, in another embodiment from about 200 to about 100000, still more preferably 500 to 10000, and in yet another embodiment from about 1000 to about 5000. If the number average molecular weight mentioned above is below 100, this will possibly impair the mixability of the water absorbing resin and water, induce formation of lumps of powder, prevent the surface cross-linkage from proceeding uniformly, and inhibit the acquisition of a sufficient water absorbency against pressure. If it exceeds about 500000, this will possibly lower the solubility of the mixing aid in water and compel the production in an actual device to incur troubles.

These mixing auxiliaries may be used either singly or in the form of a mixture of two or more members. Then, the amount of the mixing aid to be added is not particularly limited but is only required to repress the aggregation of the water absorbing resin with water, and improve the mixability of water and the water absorbing resin. In one embodiment, this amount is not less than about 0.01 weight part and less than about 50 weight parts, another embodiment in the range of from about 0.03 to about 20 weight parts, in another embodiment in the range of from about 0.05 to about 10 weight parts, in another embodiment in the range of from about 0.1 to about 5 weight parts, and in yet another embodiment in the range of from about 0.3 to about 1 weight parts per 100 weight parts of the water absorbing resin. The mixing aid may be used in the range of from about 0 to about 40 weight %, in another embodiment in the range of from about 0.01 to about 30 weight %, and in yet another embodiment in the range of from about 0.1 to about 10 weight %, based on the total amount of the aqueous solution.

Incidentally, as means to mix the water absorbing resin, water or an aqueous solution, and the mixing aid, a method which consists in effecting the mixture by the use of an ordinary mixing device such as, for example, V-shaped mixer, a ribbon type mixer, a screw type mixer, a rotary disc type mixer, an air current type mixer, a batch type kneader, a continuous kneader, a paddle type mixer, or a spade type mixer may be cited.

(c) Keeping the Mixture in a Mixed State

The method of making the water absorbing agent comprised by the absorbent member, comprises mixing the water absorbing resin, water and the mixing aid as described above and irradiating the resultant mixture with ultraviolet rays while keeping the mixture in a moving stream. Thereby, it is possible to perform the surface treatment uniformly and conspicuously exalting the water absorbency against pressure without decreasing the water absorbency against no pressure. In one embodiment, the ultraviolet rays used in this process have a wavelength of above about 200 nm and not more than about 400 nm.

For the purpose of fluidizing the mixture during the irradiation of the mixture with the ultraviolet rays, blowing a gas such as air, oxygen, or nitrogen into the mixture and fluidizing the aforementioned mixture are equally possible besides stirring the mixture.

When the mixture containing the water absorbing resin and water is fluidized by the motion of stirring, the stirring speed is from about 300 to about 1000 rpm, in another embodiment from about 400 to about 750 rpm, and in yet another embodiment from about 450 to about 550 rpm. If the stirring speed is below about 300 rpm, this will possibly prevent the ultraviolet rays from irradiating uniformly. If it exceeds about 1000 rpm, this will possibly expose the mixture to mechanical damage and increase the content of fine particles in the water absorbing agent after irradiation with the ultraviolet rays.

The fluidization of the mixture of the water absorbing resin and water or an aqueous solution and the mixing aid may be implemented by using the heretofore known device. Examples of the known devices are a shaking type mixer, a shaking feeder, a ribbon type mixer, a conical ribbon type mixer, a screw type mixing and extruding device, an air current type mixer, a batch type kneader, a continuous type kneader, a paddle type mixer, a high speed fluid type mixer, and a free ascent flow type mixer.

(d) Irradiation with Ultraviolet Rays

As a method for modifying the surface of a water absorbent resin (particles), the formation of a surface crosslinkage attained by using a surface crosslinking agent and promoting the relevant reaction by application of heat has been known to the public. For surface cross-linking the water absorbing resin as described above, compounds such as a polyhydric alcohol, a polyvalent glycidyl ether, a haloepoxy compound, or a polyvalent aldehyde which possesses a plurality of functional groups in the molecular unit thereof are used. Generally, when the polymerizing monomer component are heated to 100 to 300° C., these functional groups react with the carboxyl groups being present in the surface of the water absorbing resin and consequently induce formation of a cross-linked structure in the surface of the water absorbing resin.

Also, a method for modifying the surface of a water absorbent resin (particles) by adding a treatment liquid containing the radical polymerization compound to the water absorbing resin and irradiating the resultant mixture with active energy rays has been reported.

The method of making the water absorbing agent comprised by the absorbent member, however, is characterized by being capable of forming a cross-linked structure in the surface of a water absorbing resin by irradiating a mixture of the water absorbing resin, water and the mixing aid with active energy rays even in the absence of such a surfactant and a polymerizing monomer as mentioned above. Also by this characteristic property, it is made possible to exalt the water absorbency of the modified water absorbing agent against pressure (AAP) without lowering the water absorbency thereof against no pressure (CRC).

In one embodiment, the ultraviolet rays have a wavelength of above about 200 nm and not more than about 400 nm. In another embodiment, the ultraviolet rays have a wavelength of above about 200 nm and not more than about 350 nm are more preferably used, and the ultraviolet rays having a wavelength of above 200 nm and not more than 300 nm. If active energy rays with a wavelength exceeding about 400 nm are used, irradiation will be deficient in energy and will possibly prevent the cross-linkage of the water absorbing resin from proceeding. If the active energy rays of about 200 nm or below are used, irradiation will likely simultaneously induce cross-linkage and severance and possibly deteriorate the water absorbing resin.

As regards the conditions of the radiation, the intensity of radiation is in the range of from about 3 to about 100 mW/cm and the dosage of radiation is in the range of from about 100 to about 10000 mJ/cm² when the ultraviolet rays are used. A high-pressure mercury lamp, a reduced-pressure mercury lamp, a metal halide lamp, and a halogen lamp are examples for suitable radiation sources. As long as the ultraviolet rays have a wavelength of above about 200 nm and not more than about 400 nm, another embodiment above about 200 nm and not more than above 350 nm, and yet another embodiment above about 200 nm and not more than about 300 nm, the source may additionally emit other radiant rays and wavelengths. The way to obtain this radiation is not particularly restricted. In one embodiment, when the electron radiation is used, the accelerating voltage is from about 50 to about 800 kV and the absorbed dose rage is from about 0.1 to about 100 Mrad.

Generally, the irradiation time is not less than about 0.1 minute and less than about 60 minutes, in another embodiment not less than about 1 minute and less than about 30 minutes, another embodiment not less than about 2 minutes and less than about 20 minutes, and in yet another embodiment not less than about 3 minutes and less than about 15 minutes. For the fixed cross-link density, the time for the surface cross-linking treatment may be curtailed as when it exceeds about 60 minutes in the case of using the conventional surface cross-linking agent. If the time of radiation is below 0.1 minute, this will possibly prevent the surface treatment of the water absorbing resin from being sufficiently carried out. If it exceeds 60 minutes, this will possibly degrade the water absorbing resin due to the active energy rays.

The distance from the ultraviolet rays radiating lamp to the mixture containing the water absorbing resin, water, and the mixing aid is from about 2 to about 30 cm, in another embodiment from about 5 to about 15 cm, and in yet another embodiment from about 8 to about 15 cm. If this distance is below about 2 cm, this will possibly result in adhesion of the mixture of the water absorbing rein and water or an aqueous solution onto the irradiation lamp. If the distance exceeds about 30 cm, this will possibly not further increase the effect of the ultraviolet rays.

The surface treatment effected by irradiation with ultraviolet rays does not require any warming. It is, however, commendable to irradiate at elevated temperatures because this inhibits the risk of aggregation while mixing. It is only necessary to elevate the temperature of the water absorbing resin to less than about 150° C., in another embodiment to less than about 120° C., in another embodiment only to between room temperature and about 100° C., and in yet another embodiment to a temperature in the range of from about 50 to about 100° C. Thus, the temperature can be set lower than the conventional surface treating temperature.

According to one embodiment, irradiation does not have to be carried out in an inert environment.

(e) Other Treatments

After the irradiation of the active energy rays, the water absorbent resin may be optionally subjected to a heat treatment at a temperature in the range of from about 50 to about 250° C. for drying.

After irradiation with ultraviolet rays, the water absorbing resin may be a surface cross-linked by using any of the heretofore known surface cross-linking agents such as polyhydric alcohols, polyvalent epoxy compounds, and alkylene carbonates.

The method for producing the water absorbing agent allows addition of a liquid passage enhancing agent to the water absorbing resin before, after, or during the radiation of the active energy rays. Examples of the liquid passage enhancing agents are mineral products such as talc, kaolin, fuller's earth, bentonite, activated clay, barite, natural asphaltum, strontium ore, ilmenite, and pearlite; aluminum compounds such as aluminum sulfate 14-18 hydrates (or anhydrides), potassium aluminum sulfate dodecahydrate, sodium aluminum sulfate dodecahydrate, aluminum chloride, aluminum polychloride, and aluminum oxide and aqueous solutions thereof; other polyvalent metal salts; hydrophilic amorphous silicas (examples, dry process: product of Tokuyama K.K. sold under the trademark designation of “Reolosil QS-20”, precipitation process: products of Degussa Corp. sold under the trademark designations of “Sipernat 22S” and “Sipernat 2200”); and oxide complexes such as silicon oxide aluminum oxide magnesium oxide complex (example, product of Engelhard Corp sold under the trademark designation of “Attagel #50”), silicon oxide aluminum oxide complex, and silicon oxide magnesium oxide complex. In one embodiment, these liquid passage enhancing agents are mixed in an amount of from about 0 to about 20 weight parts, in another embodiment in an amount of from about 0.01 to about 10 weight parts, and in yet another embodiment in an amount of from about 0.1 to about 5 weight parts with 100 weight parts of the modified water absorbing resin. A water-soluble liquid passage enhancing agent is added in the form of an aqueous solution whereas a non water-soluble liquid passage enhancing agent is added in the form of powder or slurry. Other additives such as anti-fungus agent, deodorant, and chelating agent may be properly incorporated within the range mentioned above.

(f) Water Absorbing Agent

The term “water absorbing agent” as used herein refers to a water absorbing agent having a modified surface (i.e., a water absorbing agent which has undergone surface treatment).

When the method for producing a water absorbing agent is executed, the produced water absorbing agent has an exalted absorbency against pressure without decreasing the absorbency against no pressure. It has been heretofore known that the formation of a surface cross-link greatly lowers the absorbency of physiological saline against no pressure and nevertheless exalts the capacity for retaining the absorbed liquid even in a state of applying pressure, namely the absorbency against pressure. According to the method of one embodiment, the absorbency of the water absorbing resin against pressure of 2.07 kPa is increased by at least 1 g/g even without using a water-soluble radical polymerization initiator and an ethylenically unsaturated monomer. This fact is thought to indicate that the method of making the water absorbing agent has introduced a surface cross-link to the surface of the water absorbing resin. In the solid state physical properties acquired after the modification, the absorbency under pressure is not less than about 3 g/g, in another embodiment not less than about 5 g/g, another embodiment not less than about 7 g/g, and in yet another embodiment not less than about 10 g/g. Incidentally, the absorption capacity of the water absorbing resin against pressure of 2.07 kPa is the magnitude determined by the method specified in the working example cited herein below.

In one embodiment, the water absorbing agent has an absorbency against pressure of 2.07 kPa of not less than about 15 g/g and less than about 50 g/g, in another embodiment from about 18 to about 40 g/g, from about 20 to 35 g/g, and in yet another embodiment from about 25 to about 30 g/g. If the absorbency against pressure mentioned above is below about 15 g/g, this will possibly result in a water absorbing agent having an unduly small absorbency against pressure and, when the agent is used as in a disposable diaper, induce leakage of urine. If it exceeds about 50 g/g, this will possibly increase the soluble component and induce gel blocking.

In one embodiment, the absorbency against no pressure (CRC) is not less than about 8 g/g, in another embodiment not less than about 15 g/g, in another embodiment not less than 20 g/g, and in yet another embodiment not less than about 25 g/g. Though the upper limit of this absorbency is not particularly restricted, it is not more than 50 g/g, more preferably not more than 40 g/g, and still more preferably not more than 35 g/g. If the absorbency against no pressure (CRC) is below about 8 g/g, the water absorbing agent has an unduly small absorption capacity and is not suitable for use as an absorbent member in absorbent articles such as disposable diapers. If the absorbency against no pressure (CRC) exceeds about 50 g/g, this will possibly weaken the gel strength and prevent the produced water absorbing agent from excelling in the absorbency against pressure.

Further, the water absorbing agent which is obtained is characterized by having an extremely small residual monomer content. Since the water absorbing resin is used in absorbent articles such as disposable diapers, the smaller the residual monomer content is, the better the end use proves from the viewpoint of odor and safety. Ordinarily, the residual monomer content in the water absorbing resin is 200 to 500 ppm. The residual monomer content of the surface-treated water absorbing resin obtained in one embodiment is not more than about 200 ppm (the lower limit is 0 ppm) in most cases. The residual monomer content of the modified water absorbing resin is not more than about 200 ppm, more not more than 150 ppm, and still in another embodiment not more than about 100 ppm.

Further, the water absorbing agent has a small solid content compared to water absorbing agents obtained by conventional methods of modification wherein the water absorbing resin and surface cross-linking agents are subjected to elevated temperatures. This is because the method of production described herein does not require elevated temperatures for the reaction and, therefore, allows the water contained in the aqueous solution added to the water absorbing resin to remain substantially intact even after the reaction. When the water content in the water absorbing agent is large, this promotes the formation of fine particulates having a particle diameter of not more than about 150 μm, which prevents the generation of static electricity on the surface of particulates, thereby which constituting blocking during the pneumatic transportation. This results in degradation of physical properties due to physical damage occurring during pneumatic transportation. In an embodiment, the solid content of the water absorbing agent is not more than about 95%, more preferably not more than about 93%, in another embodiment not more than 90%, and particularly preferably not more than about 85%. Though the lower limit of the solid content is not particularly restricted, a solid content below about 70% possibly lowers the absorbency of the water absorbing agent per unit weight.

The form of the surface-treated water absorbing agent which is obtained can be properly adjusted by the conditions of treatment such as the form of the water absorbent resin before treatment and the agglomeration and molding of the treated water absorbent resin after the treatment. Generally, however, the modified water absorbent resin has a powdery form. This powder has a weight average particle diameter (specified by classification with sieves) which is in the range of from about 10 to about 1,000 μm and in another embodiment in the range of from about 200 to about 600 μm. In this powder, the content of particles having diameters of from about 150 to about 850 μm is in the range of from about 90 to about 100% by weight and in another embodiment in the range of from about 95 to about 100% by weight based on the weight of the water absorbent resin.

The method for production according to one embodiment causes the fine particles generated during the production of the water absorbing resin to agglomerate during surface cross-linking. Thus, even when the water absorbing resin yet to be modified happens to contain fine particles, the method for producing the water absorbing agent according to this invention enables agglomeration of the fine particles and consequently decreases the amount of fine particles contained in the surface-treated water absorbing agent. The particle-size distribution of the produced water absorbing agent is shifted towards higher particle sizes compared to the particle size of the water absorbing agent yet to be modified. The ratio of this shifting, however, is varied by the amount of water to be mixed with the water absorbing resin, the condition of radiation with ultraviolet rays, and the mode of fluidizing the mixture during radiation.

The water absorbing agent to be obtained by the method described herein have uniformly formed surface cross-links formed over the whole surface of the water absorbing resin with a high cross-link density. Thus, the water absorbing agents have the characteristic properties expected of a good water absorbing resin such as, for example, absorbency, absorption speed, gel strength, and suction force, at unusually high levels.

When this method is executed in the presence of an ethylenically unsaturated monomer, the absorption capacity against no pressure is decreased.

The water-soluble radical polymerization initiator is supposed to be dissolved in a ratio of not less than about 10 weight % in water (25° C.). Examples of this polymerization initiator are persulfates such as ammonium persulfate, sodium persulfate, and potassium persulfate; hydrogen peroxide; and water-soluble azo compounds such as 2,2′-azobis-2-amidinopropane dihydro-chloride and 2-2′-azobis[2-2(-imidazolin-2-yl)propane]dihydrochloride.

In accordance with one embodiment, the surface treatment of the water absorbent resin is effected fully satisfactorily even at a reaction temperature near room temperature and the surface-treated water absorbent agent consequently obtained is enabled to manifest at extremely high levels such characteristic properties as absorption capacity, absorption speed, gel strength, and suction force which the water absorbent resin is expected to possess. The water absorbent resin, therefore, is optimally usable for sanitary cotton, disposable diapers, and other sanitary materials for absorbing body fluid.

Absorbent Articles

In one embodiment, the absorbent members made by the method are used as absorbent cores in absorbent articles. As used herein, absorbent article refers to devices that absorb and contain liquid, and more specifically, refers to devices that are placed against or in proximity to the body of the wearer to absorb and contain the various exudates discharged from the body. Absorbent articles include but are not limited to diapers, adult incontinent briefs, diaper holders and liners, sanitary napkins and the like.

In one embodiment, absorbent articles are diapers and training pants. As used herein, “diaper” and “training pants” refers to an absorbent article generally worn by infants and incontinent persons about the lower torso.

In one embodiment, absorbent articles typically comprise an outer covering including a liquid pervious topsheet, a liquid impervious backsheet and an absorbent core generally disposed between the topsheet and the backsheet. The absorbent core may comprise any absorbent material that is generally compressible, conformable, non-irritating to the wearer's skin, and capable of absorbing and retaining liquids such as urine and other certain body exudates. In addition to the SAP particles, the absorbent core may comprise a wide variety of liquid-absorbent materials commonly used in disposable diapers and other absorbent articles such as comminuted wood pulp, which is generally referred to as air felt.

Exemplary absorbent structures for use as the absorbent assemblies are described in U.S. Pat. No. 5,137,537 entitled “Absorbent Structure Containing Individualized, Polycarboxylic Acid Crosslinked Wood Pulp Cellulose Fibers” which issued to Herron et al. on Aug. 11, 1992; U.S. Pat. No. 5,147,345 entitled “High Efficiency Absorbent Articles For Incontinence Management” issued to Young et al. on Sep. 15, 1992; U.S. Pat. No. 5,342,338 entitled “Disposable Absorbent Article For Low-Viscosity Fecal Material” issued to Roe on Aug. 30, 1994; U.S. Pat. No. 5,260,345 entitled “Absorbent Foam Materials For Aqueous Body Fluids and Absorbent Articles Containing Such Materials” issued to DesMarais et al. on Nov. 9, 1993; U.S. Pat. No. 5,387,207 entitled “Thin-Until-Wet Absorbent Foam Materials For Aqueous Body Fluids And Process For Making Same” issued to Dyer et al. on Feb. 7, 1995; U.S. Pat. No. 5,397,316 entitled “Slitted Absorbent Members For Aqueous Body Fluids Formed Of Expandable Absorbent Materials” issued to LaVon et al. on Mar. 14, 1995; and U.S. Pat. No. 5,650,222 entitled “Absorbent Foam Materials For Aqueous Fluids Made From High Internal Phase Emulsions Having Very High Water-To-Oil Ratios” issued to DesMarais et al. on Jul. 22, 1997.

### EXAMPLES

Now, various embodiments will be explained more specifically below with reference to working examples and comparative examples. This invention is not limited to these working examples. The varying properties of water absorbing resins described therein were determined by the following methods. All the operations described therein were carried out under the conditions of room temperature (20 to 25° C.) and humidity 50 RH % unless special conditions were mentioned.

(1) Centrifuge Retention Capacity (Abbreviated as CRC)

The centrifuge retention capacity (CRC) indicates the absorbency exhibited by a given sample after 30 minutes standing against no pressure in an aqueous 0.90 weight % saline solution.

A pouch (85 mm×60 mm) made of non-woven fabric (made by Nangoku Pulp Kogyo K.K. and sold under the trademark designation of “Heatlon Paper, Type GSP-22”) was packed uniformly with 0.200 g of a given water absorbing resin or water absorbent agent, heat sealed, and immersed in a large excess (generally about 500 ml) of an aqueous 0.90 weight % sodium chloride solution at room temperature. The pouch was pulled up from the solution after 30 minutes of standing therein and drained for three minutes with the centrifugal force (250 G) described in edana ABSORBENCY 11 441.1-99 by using a centrifugal separator (made by Kokusansha K.K. and sold under the product code of “Type H-122”). Then, the drained pouch was weighed to find the weight W1 (g) thereof. The same procedure was repeated without using a water absorbing resin and the drained pouch was weighed to find the weight W0 (g). Then, the centrifuge retention capacity (CRC) (g/g) was calculated in accordance with the following formula using the found values of W1 and W0.
Centrifuge retention capacity (CRC) (g/g)=(W1 (g)−W0 (g))/(weight (g) of water absorbing resin or water absorbing agent)−1

(2) Absorbency Against Pressure 0.3 psi (Abbreviated as “AAP 0.3”)

The absorbency against pressure 0.3 psi (AAP 0.3) indicates the absorbency indicated by a given sample after 60 minutes' standing under pressure of 2.07 kPa (0.3 psi) in an aqueous 0.90 weight % saline solution.

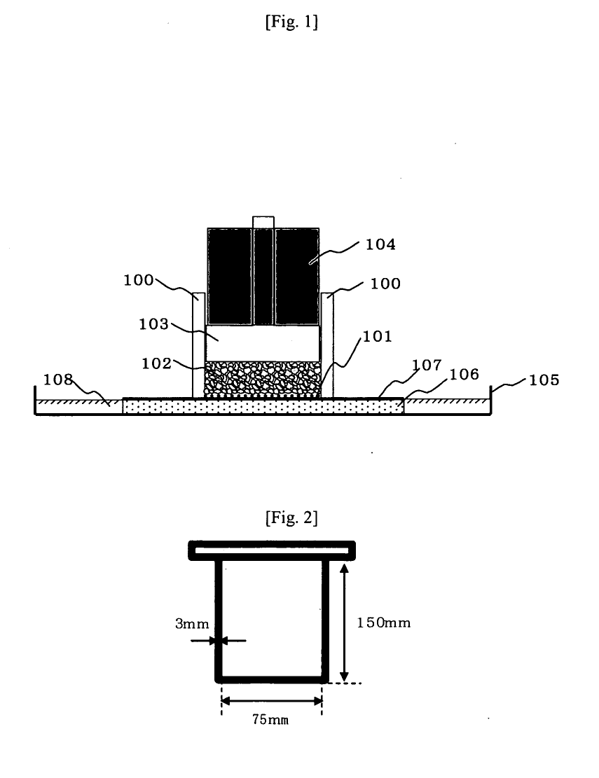

In an apparatus illustrated in FIG. 1, a 400-mesh metal gauze 101 (aperture 38 μm) made of stainless steel was fused to the bottom of a plastic supporting cylinder 100 having an inside diameter of 60 mm. On the metal gauze, 0.900 g of a given water absorbing resin or water absorbing agent was uniformly scattered under the conditions of room temperature (20 to 25° C.) and humidity 50 RH % and a piston 103 and a load 104 adjusted so as to exert a load of 2.07 kPa (0.3 psi) on the scattered sample, given an outside diameter slightly smaller than 60 mm and prevented from producing an interspace between themselves and the supporting cylinder, and enabled to produce an uninterrupted vertical motion were mounted on the scattered sample sequentially in the order mentioned. The whole of the apparatus was weighed to find the weight W2 (g) thereof.

Inside a petri dish 105 having a diameter of 150 mm, a glass filter 106 having a diameter of 90 mm (made by Sogo Rikagaku Glass Seisakusho K.K., having a pore diameter of 100 to 120 μm) was placed and an aqueous 0.90 weight % saline solution 108 (20 to 25° C.) was added till the same level as the upper surface. On the soaked glass filter in the petri dish, one filter paper 107 having a diameter of 90 mm (made by ADVANTEC Toyo K.K. and sold under the product name “JIS P 3801, No. 2,” and having a thickness of 0.26 mm and a retention particle diameter of 5 μm) was placed so as to have the surface completely wetted, with the excess liquid removed therefrom.

The whole apparatus mentioned above was placed on the aforementioned filter paper and the water absorbing resin or the water absorbing agent was left absorbing the liquid under the load. After the lapse of 60 minutes, the whole apparatus was lifted and weighed to find the weight W3 (g) thereof. The absorbency against pressure 0.3 psi (AAP 0.3) (g/g) was calculated in accordance with the following formula, using the found weights W2 and W3.
Absorbency against pressure 0.3 psi (AAP 0.3)=(W3 (g)−W2 (g))/(Weight of water absorbing resin or water absorbing agent (0.900 g))

(3) Weight Average Particle Diameter (D50) and Logarithmic Standard Deviation of Particle Diameter Distribution (σζ)

A given water absorbing resin was classified with JIS standard sieves (JIS Z 8801-1 (2550)) measuring 850 μm, 710 μm, 600 μm, 500 μm, 425 μm, 300 μm, 212 μm, 150 μm, 106 μm, and 45 μm in aperture and the residual percentages R consequently found were plotted on a logarithmic probability paper. The particle diameter corresponding to R=50 weight % was read out as the weight average particle diameter (D50). Let X1 stand for the particle diameter for R=84.1% and X2 the particle diameter for R=15.9% respectively, and the logarithmic standard deviation (σζ) will be expressed by the following formula. The magnitude (σζ) signifies that the particle size distribution narrows in accordance as this magnitude decreases.
σζ=0.5×ln(X2/X1)

The classification adopted in determining the logarithmic standard deviation (σζ) in the particle size distribution was effected by charging the JIS standard sieves (the Iida Testing Sieves: diameter 8 cm) measuring 850 μm, 710 μm, 600 μm, 500 μm, 425 sun, 300 μm, 212 μm, 150 μm, 106 μm, and 45 μm in aperture with 10.0 g of a given water absorbing resin under the conditions of room temperature (20 to 25° C.) and humidity 50 RH % and shaking the sieves with a shaking classifier (Iida Sieve Shaker, Type ES-65, Ser No. 0501).

(4) Eluted Soluble Content

In a plastic container having an inner volume of 250 ml and furnished with a lid, 184.3 g of an aqueous 0.9 weight % saline solution was placed, 1.00 g of a given water absorbing resin or water absorbing agent was added to the aqueous solution, and they were stirred by rotating a stirrer so as to extract an eluted soluble component from the resin for 16 hours. The extracted liquid was filtered with one filter paper (made by ADVANTEC Toyo K.K. and sold under the product name “JIS P 3801, No. 2,” and having a thickness of 0.26 mm and a retention particle diameter of 5 μm). The portion 50.0 g of the resultant filtrate was taken as a test solution.

First, 50.0 g of an aqueous 0.9 weight % saline solution alone was titrated first with an aqueous 0.1N NaOH solution till pH 10 and then with an aqueous 0.1N HCl solution till pH 2.7 to obtain titers ([bNaOH] ml and [bHCl] ml).

By performing the same titrating operation on the test solution, the titers ([NaOH] ml and [HCl] ml) were obtained.

In the case of a water absorbing resin formed of known amounts of acrylic acid and a sodium salt thereof, for example, the eluted soluble content of the water absorbing resin was calculated in accordance with the following formula, based on the average molecular weight of the monomer and the titers found by the aforementioned operation. When the amounts mentioned above were unknown, the average molecular weight of the monomer was calculated by using the neutralization degree determined by titration.
Eluted soluble content (weight %)=0.1×(average molecular weight of monomer)×184.3×100×([HCl]−[bHCl])/1000/1.0/50.0
Neutralization degree (mol %)=(1−([NaOH]−[bNaOH])/([HCl]−[bHCl]))×100

(5) Water Content

In an aluminum cup measuring 4 cm in diameter of bottom surface and 2 cm in height, 1.00 g of a given water absorbing resin was uniformly scattered on the bottom surface of the aluminum cup. The aluminum cup containing the absorbing agent was weighed to find the weight W4 (g). It was left standing in a hot air drier adjusted at 180° C. for 3 hours. The agent-containing aluminum cup was weighed to find the weight W5 (g) immediately after it was taken out of the hot air drier (within less than 1 minute). The water content (weight %) was calculated in accordance with the following formula using these weights W4 and W5.
Water content (weight %)={W4 (g)−W5 (g))/(weight (g) of water absorbing resin)×100

(6) Surface Tension of Mixing Aid Solution

In a thoroughly washed 100 mL beaker, 40 mL of purified water of 20° C. was placed and the purified water was tested for surface tension by the use of a surface tension meter (made by Kruss Corp and sold under the trademark designation of “Kll Automatic Surface Tension Meter”). In this determination, the magnitude of surface tension must be in the range of 72 to 74 dynes/cm. Then, the mixing aid solution adjusted to 20° C. was tested for surface tension by following the same procedure. Incidentally, this invention adopted the plate method using a platinum plate, which was thoroughly cleaned with water prior to each determination and thermally cleaned with a burner prior to use.

### Referential Example 1

In a reaction vessel formed by attaching a stopper to a jacketed stainless steel twin arm type kneader furnished with two sigma type vanes and having an inner volume of 10 liters, 8.55 g of polyethylene glycol diacrylate was dissolved in 5446 g of an aqueous sodium acrylate solution having the monomer concentration of 39 weight % and the neutralization degree of 60 mol % to prepare a reaction solution. Then, this reaction solution was deaerated in an atmosphere of nitrogen gas for 30 minutes. When 20.1 g of an aqueous 10 weight % sodium persulfate solution and 25.2 g of an aqueous 0.1 weight % L-ascorbic acid solution were subsequently added as kept stirred to the reaction solution, polymerization was initiated within about one minute of adding the aqueous solutions. Then, the polymerization was carried out at 20 to 95° C. while the formed gel was continuously pulverized. After the elapse of 30 minutes subsequent to the start of polymerization, a hydrogel-like cross-linked polymer was taken out. The produced hydrogel-like cross-linked polymer was in a form finely divided into particulates not more than about 5 mm in diameter. This finely divided hydrogel-like cross-linked polymer was spread on a 50-mesh metal gauze (aperture 300 μm) and dried with hot air at 175° C. for 50 minutes. Thus, a water absorbing resin (A) formed of indeterminately shaped, easily pulverizable aggregates of a particulate or powdery dry product was obtained.

The water absorbing resin (A) was pulverized with a roll mill and further classified with a JIS standard sieve having an aperture of 710 μm. Then, the particles which had passed the apertures of 710 μm in the foregoing operation were classified with a JIS standard sieve having an aperture of 150 μm to remove the water absorbing resin particles which had passed the JIS standard sieve of an aperture of 150 μm. Thus, a water absorbing resin (A1) was obtained. The water absorbing resin (A1) was rated to determine various properties. As a result of the rating, physical properties shown in Table 1 and the various particle size distributions shown in Table 2 were obtained.

### Referential Example 2

In a reaction vessel formed by attaching a stopper to a jacketed stainless steel twin arm type kneader furnished with two sigma type vanes and having an inner volume of 10 liters, 7.95 g of polyethylene glycol diacrylate was dissolved in 5438 g of an aqueous sodium acrylate solution having the monomer concentration of 39 weight % and the neutralization degree of 70 mol % to prepare a reaction solution. Then, this reaction solution was deaerated in an atmosphere of nitrogen gas for 30 minutes. When 29.43 g of an aqueous 10 weight % sodium persulfate solution and 24.53 g of an aqueous 0.1 weight % L-ascorbic acid solution were subsequently added as kept stirred to the reaction solution, polymerization was initiated within about one minute of adding the aqueous solutions. Then, the polymerization was carried out at 20 to 95° C. while the formed gel was continuously pulverized. After the elapse of 30 minutes subsequent to the start of polymerization, a hydrogel-like cross-linked polymer was taken out. The produced hydrogel-like cross-linked polymer was in a form finely divided into particulates not more than about 5 mm in diameter. This finely divided hydrogel-like cross-linked polymer was spread on a 50-mesh metal gauze (aperture 300 μm) and dried with hot air at 175° C. for 50 minutes. Thus, a water absorbing resin (B) formed of indeterminately shaped, easily pulverizable aggregates of a particulate or powdery dry product was obtained.

The water absorbing resin (B) was pulverized with a roll mill and further classified with a JIS standard sieve having an aperture of 710 μm. Then, the particles which had passed the apertures of 710 μm in the foregoing operation were classified with a JIS standard sieve having an aperture of 150 μm to remove the water absorbing resin particles which had passed the JIS standard sieve of an aperture of 150 μm. Thus, a water absorbing resin (B1) was obtained. The water absorbing resin (B1) was rated to determine various properties. As a result of the rating, physical properties shown in Table 1 and the various particle size distributions shown in Table 2 were obtained.

### Referential Example 3

In a reaction vessel formed by attaching a stopper to a jacketed stainless steel twin arm type kneader furnished with two sigma type vanes and having an inner volume of 10 liters, 9.39 g of polyethylene glycol diacrylate was dissolved in 5447 g of an aqueous sodium acrylate solution having the monomer concentration of 39 weight % and the neutralization degree of 80 mol % to prepare a reaction solution. Then, this reaction solution was deaerated in an atmosphere of nitrogen gas for 30 minutes. When 19.1 g of an aqueous 10 weight % sodium persulfate solution and 23.9 g of an aqueous 0.1 weight % L-ascorbic acid solution were subsequently added as kept stirred to the reaction solution, polymerization was initiated within about one minute of adding the aqueous solutions. Then, the polymerization was carried out at 20 to 95° C. while the formed gel was continuously pulverized. After the elapse of 30 minutes subsequent to the start of polymerization, a hydrogel-like cross-linked polymer was taken out. The produced hydrogel-like cross-linked polymer was in a form finely divided into particulates not more than about 5 mm in diameter. This finely divided hydrogel-like cross-linked polymer was spread on a 50-mesh metal gauze (aperture 300 μm) and dried with hot air at 175° C. for 50 minutes. Thus, a water absorbing resin (C) formed of indeterminately shaped, easily pulverizable aggregates of a particulate or powdery dry product was obtained.

The water absorbing resin (C) was pulverized with a roll mill and further classified with a JIS standard sieve having an aperture of 710 μm. Then, the particles which had passed the apertures of 710 μm in the foregoing operation were classified with a JIS standard sieve having an aperture of 150 μm to remove the water absorbing resin particles which had passed the JIS standard sieve of an aperture of 150 μm. Thus, a water absorbing resin (C1) was obtained. The water absorbing resin (C1) was rated to determine various properties. As a result of the rating, physical properties shown in Table 1 and the various particle size distributions shown in Table 2 were obtained.

### Referential Example 4

In a reaction vessel formed by attaching a stopper to a jacketed stainless steel twin arm type kneader furnished with two sigma type vanes and having an inner volume of 10 liters, 6.04 g of polyethylene glycol diacrylate was dissolved in 5452 g of an aqueous sodium acrylate solution having the monomer concentration of 39 weight % and the neutralization degree of 90 mol to prepare a reaction solution. Then, this reaction solution was deaerated in an atmosphere of nitrogen gas for 30 minutes. When 19.1 g of an aqueous 10 weight % sodium persulfate solution and 23.9 g of an aqueous 0.1 weight % L-ascorbic acid solution were subsequently added as kept stirred to the reaction solution, polymerization was initiated within about one minute of adding the aqueous solutions. The polymerization was carried out at 20 to 95° C. while the formed gel was continuously pulverized. After the elapse of 30 minutes subsequent to the start of polymerization, a hydrogel-like cross-linked polymer was taken out. The produced hydrogel-like cross-linked polymer was in a form finely divided into particulates not more than about 5 mm in diameter. This finely divided hydrogel-like cross-linked polymer was spread on a 50-mesh metal gauze (aperture 300 μm) and dried with hot air at 175° C. for 50 minutes. Thus, a water absorbing resin (D) formed of indeterminately shaped, easily pulverizable aggregates of a particulate or powdery dry product was obtained.

The water absorbing resin (D) was pulverized with a roll mill and further classified with a JIS standard sieve having an aperture of 710 μm. Then, the particles which had passed the apertures of 710 μm in the foregoing operation were classified with a JIS standard sieve having an aperture of 150 μm to remove the water absorbing resin particles which had passed the JIS standard sieve of an aperture of 150 μm. Thus, a water absorbing resin (D1) was obtained. The water absorbing resin (D1) was rated to determine various properties. As a result of the rating, physical properties shown in Table 1 and the various particle size distributions shown in Table 2 were obtained.

### Referential Example 5

The water absorbing resin (A) described in Referential Example 1 was pulverized with a pin mill and further classified with the JIS sieve having an aperture of 500 μm to remove the water absorbing resin particles which do not pass on the JIS sieve having an aperture of 500 μm. Thus, a water absorbing resin (A2) was obtained. This water absorbing resin (A2) was rated to determine various properties. As a result of the rating, physical properties shown in Table 1 and the various particle size distributions shown in Table 2 were obtained.

### Referential Example 6

The water absorbing resin (A) described in Referential Example 1 was pulverized with a pin mill and further classified with the JIS sieve having an aperture of 710 μm to remove the water absorbing resin particles which do not pass on the JIS sieve having an aperture of 710 μm. Thus, a water absorbing resin (A3) was obtained. This water absorbing resin (A3) was rated to determine various properties. As a result of the rating, physical properties shown in Table 1 and the various particle size distributions shown in Table 2 were obtained.

### Example 1

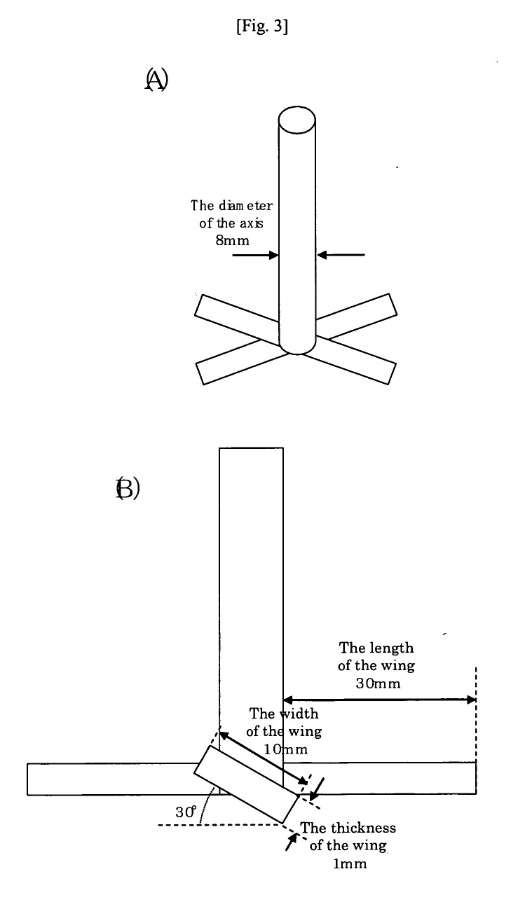

In a separable flask made of quartz (illustrated in FIG. 2), 10 g of the water absorbing resin (A1) was placed and stirred with stirring vanes (illustrated in FIG. 3) at 500 rpm meanwhile 0.85 g of an aqueous 5.88 weight % polyethylene glycol methyl ether Mn 2000 (PEG-OMe 2000: CH₃(OCH₂CH₂)ₙOH, number average molecular weight Mn: 20000, made by Aldrich Corp.) solution was added thereto. After the stirring was continued for 10 minutes, the stirred mixture was irradiated with an ultraviolet rays at a radiation intensity of 60 mW/cm² for 10 minutes at room temperature by using an ultraviolet rays radiating device (made by Ushio Denki K.K. and sold under the product code of “UV-152/IMNSC3-AA06”) furnished with a metal halide lamp (made by the same company and sold under the product code of “UVL-1500M2-N1”) to obtain a surface-treated water absorbing agent (1).

The conditions for the synthesis of the produced water absorbing agent (1) are shown in Table 3 and the results of the test of this agent for various physical properties are shown in Table 4.

The various physical properties concerning “the water contents of 8 weight % corrected” indicated in Table 4 were the magnitudes calculated in accordance with the following formula.
CRC (g/g) after correction of water content of 8 weight %=(CRC (g/g) with no correction of water content+1)/0.92−1
AAP 0.3 (g/g) after correction of water content of 8 weight %=AAP 0.3 (g/g) with no correction of water content/0.92
Eluted soluble content (weight %) after correction of water content of 8 weight %=Eluted soluble content with no correction of water content (weight %)/0.92

### Example 2

A surface-treated water absorbing agent (2) was obtained by following the procedure of Example 1 while using 10 g of the water absorbing resin (B1) instead and changing the rotational frequency of the stirring vanes to 450 rpm. The conditions for the synthesis of the produced water absorbing agent (2) are shown in Table 3 and the results of the test of this agent for various physical properties are shown in Table 4.

### Example 3

A surface-treated water absorbing agent (3) was obtained by following the procedure of Example 1 while using 10 g of the water absorbing resin (C1) instead. The conditions for the synthesis of the produced water absorbing agent (3) are shown in Table 3 and the results of the test of this agent for various physical properties are shown in Table 4.

### Example 4

A surface-treated water absorbing agent (4) was obtained by following the procedure of Example 1 while using 10 g of the water absorbing resin (D1) instead. The conditions for the synthesis of the produced water absorbing agent (4) are shown in Table 3 and the results of the test of this agent for various physical properties are shown in Table 4.

### Example 5

A surface-treated water absorbing agent (5) was obtained by following the procedure of Example 1 while using 0.85 g of an aqueous 5.88 weight % polyethylene glycol methyl ether Mn 550 (PEG-OMe 550: CH₃(OCH₂CH₂)ₙOH, number average molecular weight Mn: 550, made by Aldrich Corp.) solution instead and changing the rotational frequency of the stirring vanes to 400 rpm. The conditions for the synthesis of the produced water absorbing agent (5) are shown in Table 3 and the results of the test of this agent for various physical properties are shown in Table 4.

### Example 6

A surface-treated water absorbing agent (6) was obtained by following the procedure of Example 1 while using 0.85 g of an aqueous 5.88 weight % polyethylene glycol methyl ether Mn 5000 (PEG-OMe 5000: CH₃(OCH₂CH₂)ₙOH, number average molecular weight Mn: 5000, made by Aldrich Corp.) solution instead and changing the rotational frequency of the stirring vanes to 400 rpm. The conditions for the synthesis of the produced water absorbing agent (6) are shown in Table 3 and the results of the test of this agent for various physical properties are shown in Table 4.

### Example 7

A surface-treated water absorbing agent (7) was obtained by following the procedure of Example 1 while using 0.85 g of an aqueous 5.88 weight % polyethylene glycol Mn 600 (PEG 600:H(OCH₂CH₂)ₙOH, number average molecular weight Mn: 600, made by Wako Junyaku Kogyo K.K.) solution instead and changing the rotational frequency of the stirring vanes to 600 rpm. The conditions for the synthesis of the produced water absorbing agent (7) are shown in Table 3 and the results of the test of this agent for various physical properties are shown in Table 4.

### Example 8

A surface-treated water absorbing agent (8) was obtained by following the procedure of Example 1 while using 0.85 g of an aqueous 5.88 weight % polyethylene glycol Mn 2000 (PEG 200: H(OCH₂CH₂)ₙOH, number average molecular weight Mn: 2000, made by Wako Junyaku Kogyo K.K.) solution instead and changing the rotational frequency of the stirring vanes to 600 rpm. The conditions for the synthesis of the produced water absorbing agent (8) are shown in Table 3 and the results of the test of this agent for various are shown in Table 4.

### Example 9

A surface-treated water absorbing agent (9) was obtained by following the procedure of Example 1 while using 0.85 g of an aqueous 5.88 weight % polyethylene glycol Mn 6000 (PEG 6000: H(OCH₂CH₂)ₙOH, number average molecular weight Mn: 6000, made by Kishida Kagaku K.K.) solution instead and changing the rotational frequency of the stirring vanes to 600 rpm. The conditions for the synthesis of the produced water absorbing agent (9) are shown in Table 3 and the results of the test of this agent for various physical properties are shown in Table 4.

### Comparative Example 1

In a separable flask made of quartz, 10 g of the water absorbing resin (A1) was placed, stirred with stirring vanes at 500 rpm, and irradiated with an ultraviolet rays at a radiation intensity of 60 mW/cm² for 10 minutes at room temperature by using an ultraviolet rays radiating device (made by Ushio Denki K.K. and sold under the product code of “IV-152/IMNSC3-AA06”) furnished with a metal halide lamp (made by the same company and sold under the product code of “UVL-1500M2-N1”) to obtain a comparative surface-treated water absorbing agent (1). The conditions for the synthesis of the produced comparative water absorbing agent (1) are shown in Table 3 and the results of the test of this agent for various physical properties are shown in Table 4.

### Comparative Example 2

A comparative water absorbing agent (2) was obtained by following the procedure of Comparative Example 1 while using 10 g of the water absorbing resin (B1) instead. The conditions for the synthesis of the produced comparative water absorbing agent (2) are shown in Table 3 and the results of the test of this agent for various physical properties are shown in Table 4.

### Comparative Example 3

In a separable flask made of quartz, 10 g of the water absorbing resin (B1) was placed and stirred with stirring vanes at 450 rpm meanwhile 1.30 g of an aqueous 38.5 weight % ammonium persulfate (APS) solution was added thereto. After the stirring was continued for 10 minutes, the stirred mixture was irradiated with an ultraviolet rays at a radiation intensity of 60 mW/cm² for 10 minutes at room temperature by using an ultraviolet rays radiating device (made by Ushio Denki K.K. and sold under the product code of “UV-152/IMNSC3-AA06”) furnished with a metal halide lamp (made by the same company and sold under the product code of “UVL-1500M2-N1”) to obtain a comparative surface-treated water absorbing agent (3). The conditions for the synthesis of the produced comparative water absorbing agent (3) are shown in Table 3 and the results of the test of this agent for various physical properties are shown in Table 4.

### Comparative Example 4

In a separable flask made of quartz, 10 g of the water absorbing resin (A1) was placed and stirred with stirring vanes at 450 rpm meanwhile 0.80 g of purified water was added thereto. A comparative water absorbing agent (4) was obtained by continuing the stirring for 10 minutes. The conditions for the synthesis of the produced comparative water absorbing agent (4) are shown in Table 3 and the results of the test of this agent for various physical properties are shown in Table 4.

### Comparative Example 5

In a separable flask made of quartz, 10 g of the water absorbing resin (A1) was placed and stirred with stirring vanes at 450 rpm meanwhile 0.85 g of an aqueous 5.88 weight % polyethylene glycol methyl ether Mn 2000 (CH₃(OCH₂CH₂)ₙOH, number average molecular weight Mn: 2000, made by Aldrich Corp.) solution. A comparative water absorbing agent (5) was obtained by continuing the stirring for 10 minutes. The conditions for the synthesis of the produced comparative water absorbing agent (5) are shown in Table 3 and the results of the test of the agent for various physical properties are shown in Table 4.

### Comparative Example 6

A comparative water absorbing agent (6) having surface treated part of the water absorbing resin thereof was obtained by following the procedure of Example 1 while using 0.80 g of a purified water in the place of the aqueous 5.88 weight % polyethylene glycol methyl ether and omitting the rotation with the stirring vanes during the radiation of the ultraviolet rays. The conditions for the synthesis of the produced comparative water absorbing agent (6) are shown in Table 3 and the results of the test of the agent for various physical properties are shown in Table 4.

### Comparative Example 7

A comparative water absorbing agent (7) having surface treated part of the water absorbing resin thereof was obtained by following the procedure of Example 1 while omitting the rotation with the stirring vanes during the radiation of the ultraviolet rays. The conditions for the synthesis of the produced comparative water absorbing agent (7) are shown in Table 3 and the results of the test of the agent for various physical properties are shown in Table 4.

### Comparative Example 8

In a separable flask made of quartz, 10 g of the water absorbing resin (A2) was placed and stir red with stirring vanes at 450 rpm meanwhile 0.80 g of purified water was added thereto. After the stirring was continued for 10 minutes, the stirred mixture was irradiated with an ultraviolet rays at a radiation intensity of 60 mW/cm² for 10 minutes at room temperature by using an ultraviolet rays radiating device (made by Ushio Denki K.K. and sold under the product code of “UV-152/IMNSC3-AA06”) furnished with a metal halide lamp (made by the same company and sold under the product code of “UVL-1500M2-N1”) to obtain a comparative surface-treated water absorbing agent (8). The conditions for the synthesis of the produced comparative water absorbing agent (8) are shown in Table 3 and the results of the test of this agent for various physical properties are shown in Table 4.

### Comparative Example 9

A comparative water absorbing agent (9) was obtained by following the procedure of Comparative Example 8 while using 10 g of the water absorbing resin (A3) instead. The conditions for the synthesis of the produced comparative water absorbing agent (9) are shown in Table 3 and the results of the test of this agent for various physical properties are shown in Table 4.

TABLE 1

| | Neutrali- | | | | Eluted |
|---|---|---|---|---|---|
| Water | zation | | AAP | Water | soluble |
| absorbing | degree | CRC | 0.3 | content | content |
| resin | (mol %) | (g/g) | (g/g) | (weight %) | (weight %) |
| Water | 60 | 35.1 | 12.6 | 5.7 | 13.3 |
| absorbing | | | | | |
| resin (A1) | | | | | |
| Water | 70 | 34.5 | 11.8 | 6.3 | 12.2 |
| absorbing | | | | | |
| resin (B1) | | | | | |
| Water | 80 | 32.4 | 14.2 | 5.5 | 6.7 |
| absorbing | | | | | |
| resin (C1) | | | | | |
| Water | 90 | 34.6 | 6.6 | 6.1 | 11.4 |
| absorbing | | | | | |
| resin (D1) | | | | | |
| Water | 60 | 33.9 | 10.1 | | — |
| absorbing | | | | | |
| resin (A2) | | | | | |
| Water | 60 | 34.1 | 10.3 | | — |
| absorbing | | | | | |
| resin (A3) | | | | | |

TABLE 2

| | Referential Example | | | | | |
|---|---|---|---|---|---|---|
| | 1 | 2 | 3 | 4 | 5 | 6 |
| Water | A1 | B1 | C1 | D1 | A2 | A3 |
| absorbing | | | | | | |
| resin | | | | | | |
| D50 (μm) | 345 | 346 | 322 | 323 | 231 | 242 |
| σζ | 0.327 | 0.332 | 0.359 | 0.339 | 0.413 | 0.472 |
| Particle size | | | | | | |
| distribution | | | | | | |
| Not less than | 0.0 | 0.0 | 0.0 | 0.0 | 0.0 | 0.0 |
| 850 μm | | | | | | |
| (weight %) | | | | | | |
| 850 to 710 | 0.1 | 0.2 | 0.0 | 0.0 | 0.0 | 0.0 |
| μm (weight | | | | | | |
| %) | | | | | | |
| 710 to 600 | 1.0 | 1.5 | 0.0 | 0.0 | 0.0 | 0.8 |
| μm (weight | | | | | | |
| %) | | | | | | |
| 600 to 500 | 3.7 | 4.1 | 2.7 | 1.9 | 0.0 | 2.3 |
| μm (weight | | | | | | |
| %) | | | | | | |
| 500 to 425 | 21.7 | 22.6 | 19.2 | 18.8 | 7.1 | 8.8 |
| μm (weight | | | | | | |
| %) | | | | | | |
| 425 to 300 | 39.6 | 37.1 | 36.2 | 37.8 | 18.9 | 19.4 |
| μm (weight | | | | | | |
| %) | | | | | | |
| 300 to 212 | 23.0 | 23.9 | 26.6 | 28.1 | 32.4 | 30.7 |
| μm (weight | | | | | | |
| %) | | | | | | |
| 212 to 150 | 9.3 | 9.3 | 12.6 | 10.3 | 26.7 | 22.5 |
| μm (weight | | | | | | |
| %) | | | | | | |
| 150 to 45 | 1.5 | 1.3 | 2.6 | 3.1 | 12.6 | 13.1 |
| μm (weight | | | | | | |
| %) | | | | | | |
| Not more | 0.1 | 0.0 | 0.1 | 0.0 | 2.3 | 2.4 |
| than 45 μm | | | | | | |
| (weight %) | | | | | | |
| Total | 100.0 | 100.0 | 100.0 | 100.0 | 100.0 | 100.0 |
| (weight %) | | | | | | |

(Not less than A μm) This indicates a water absorbing resin which does not pass a sieve of an aperture of A μm during classification.
(Not more than B μm) This indicates a water absorbing resin passed through a sieve of an aperture of B μm during classification.

(C-D μm) This indicates a water absorbing resin passed through a sieve of an aperture of C μm and does not pass a sieve of an aperture of D μm during classification.

TABLE 3

| | | Additive composition | | | |
|---|---|---|---|---|---|
| | | and ratio thereof | | Rotational frequency of | |
| | Water | (weight %) to water | Surface tension of | stirring vanes during | |
| Example | absorbing | absorbing resin | additive solution | radiation of UV | Duration of |
| No. | agent | (A1-D1) | (dynes/cm) | (rpm) | UV radiation |
| Example 1 | Water | W*)/PEG-OMe2000 = 8/0.5 | 51.7 | 500 | 10 |
| | absorbing | | | | minutes |
| | agent (1) | | | | |
| Example 2 | Water | W*)/PEG-OMe2000 = 8/0.5 | 51.7 | 450 | 10 |
| | absorbing | | | | minutes |
| | agent (2) | | | | |
| Example 3 | Water | W*)/PEG-OMe2000 = 8/0.5 | 51.7 | 500 | 10 |
| | absorbing | | | | minutes |
| | agent (3) | | | | |
| Example 4 | Water | W*)/PEG-OMe2000 = 8/0.5 | 51.7 | 500 | 10 |
| | absorbing | | | | minutes |
| | agent (4) | | | | |
| Example 5 | Water | W*)/PEG-OMe550 = 8/0.5 | | 400 | 10 |
| | absorbing | | | | minutes |
| | agent (5) | | | | |
| Example 6 | Water | W*)/PEG-OMe5000 = 8/0.5 | | 400 | 10 |
| | absorbing | | | | minutes |
| | agent (6) | | | | |
| Example 7 | Water | W*)/PEG600 = 8/0.5 | | 600 | 10 |
| | absorbing | | | | minutes |
| | agent (7) | | | | |
| Example 8 | Water | W*)/PEG2000 = 8/0.5 | | 600 | 10 |
| | absorbing | | | | minutes |
| | agent (8) | | | | |
| Example 9 | Water | W*)/PEG6000 = 8/0.5 | | 600 | 10 |
| | absorbing | | | | minutes |
| | agent (9) | | | | |
| Comparative | Comparative | — | | 500 | 10 |
| Example 1 | Water | | | | minutes |
| | absorbing | | | | |
| | agent (1) | | | | |
| Comparative | Comparative | — | | 500 | 10 |
| Example 2 | Water | | | | minutes |
| | absorbing | | | | |
| | agent (2) | | | | |
| Comparative | Comparative | W*)/APS = 8/5 | | 450 | 10 |
| Example 3 | Water | | | | minutes |
| | absorbing | | | | |
| | agent (3) | | | | |
| Comparative | Comparative | W*) = 8 | 73 | | |
| Example 4 | Water | | | | |
| | absorbing | | | | |
| | agent (4) | | | | |
| Comparative | Comparative | W*)/PEG-OMe2000 = 8/0.5 | 51.7 | | |
| Example 5 | Water | | | | |
| | absorbing | | | | |
| | agent (5) | | | | |
| Comparative | Comparative | W*) = 8 | 73 | 0 | 10 |
| Example 6 | Water | | | | minutes |
| | absorbing | | | | |
| | agent (6) | | | | |
| Comparative | Comparative | W*)/PEG-OMe2000 = 8/0.5 | 51.7 | 0 | 10 |
| Example 7 | Water | | | | minutes |
| | absorbing | | | | |
| | agent (7) | | | | |
| Comparative | Comparative | W*) = 8 | 73 | 500 | 10 |
| Example 8 | Water | | | | minutes |
| | absorbing | | | | |
| | agent (8) | | | | |
| Comparative | Comparative | W*) = 8 | 73 | 500 | 10 |
| Example 9 | Water | | | | minutes |
| | absorbing | | | | |
| | agent (9) | | | | |

*)W: purified water

TABLE 4

| | | Water content not | | | Water content of 8 weight % | | |
|---|---|---|---|---|---|---|---|
| | | corrected | | | corrected** | | |
| | | | | Eluted | | | Eluted |
| | Water | | AAP | soluble | | AAP | soluble |
| Example | absorbing | CRC | 0.3 | content | CRC | 0.3 | content |
| No. | agent | (g/g) | (g/g) | (weight %) | (g/g) | (g/g) | (weight %) |
| Example 1 | Water | 32.5 | 27.8 | 12.8 | 35.4 | 30.2 | 14.0 |
| | absorbing | | | | | | |
| | agent (1) | | | | | | |
| Example 2 | Water | 31.6 | 26.5 | 11.8 | 34.4 | 28.8 | 12.8 |
| | absorbing | | | | | | |
| | agent (2) | | | | | | |
| Example 3 | Water | 28.8 | 25.4 | — | 31.4 | 27.6 | — |
| | absorbing | | | | | | |
| | agent (3) | | | | | | |
| Example 4 | Water | 32.3 | 18.6 | — | 35.2 | 20.2 | — |
| | absorbing | | | | | | |
| | agent (4) | | | | | | |
| Example 5 | Water | 32.5 | 28.8 | — | 35.7 | 31.3 | — |
| | absorbing | | | | | | |
| | agent (5) | | | | | | |
| Example 6 | Water | 31.9 | 27.1 | — | 34.8 | 29.5 | — |
| | absorbing | | | | | | |
| | agent (6) | | | | | | |
| Example 7 | Water | 32.9 | 28.2 | — | 35.8 | 30.7 | — |
| | absorbing | | | | | | |
| | agent (7) | | | | | | |
| Example 8 | Water | 33 | 28.0 | — | 36.0 | 30.4 | — |
| | absorbing | | | | | | |
| | agent (8) | | | | | | |
| Example 9 | Water | 32.1 | 27.0 | — | 35.0 | 29.3 | — |
| | absorbing | | | | | | |
| | agent (9) | | | | | | |
| Comparative | Comparative | 37.6 | 9.6 | 15.6 | — | — | — |
| Example 1 | Water | | | | | | |
| | absorbing | | | | | | |
| | agent (1) | | | | | | |
| Comparative | Comparative | 36.1 | 8.2 | 13.5 | — | — | — |
| Example 2 | Water | | | | | | |
| | absorbing | | | | | | |
| | agent (2) | | | | | | |
| Comparative | Comparative | 24.0 | 26.1 | | 26.2 | 28.4 | — |
| Example 3 | Water | | | | | | |
| | absorbing | | | | | | |
| | agent (3) | | | | | | |
| Comparative | Comparative | 32.7 | 11.9 | | 35.6 | 12.9 | — |
| Example 4 | Water | | | | | | |
| | absorbing | | | | | | |
| | agent (4) | | | | | | |
| Comparative | Comparative | 33.4 | 11.5 | | 36.4 | 12.5 | — |
| Example 5 | Water | | | | | | |
| | absorbing | | | | | | |
| | agent (5) | | | | | | |
| Comparative | Comparative | 32.7 | 14.2 | | 35.6 | 15.4 | — |
| Example 6 | Water | | | | | | |
| | absorbing | | | | | | |
| | agent (6) | | | | | | |
| Comparative | Comparative | 32.2 | 14.8 | | 35.1 | 16.1 | — |
| Example 7 | Water | | | | | | |
| | absorbing | | | | | | |
| | agent (7) | | | | | | |
| Comparative | Comparative | 31.6 | 14.1 | — | 34.3 | 15.3 | — |
| Example 8 | Water | | | | | | |
| | absorbing | | | | | | |
| | agent (8) | | | | | | |
| Comparative | Comparative | 31.2 | 14.8 | — | 33.9 | 15.7 | — |
| Example 9 | Water | | | | | | |
| | absorbing | | | | | | |
| | agent (9) | | | | | | |

**Water content corrected: Water content of water absorbing resin as determined, and water content of water absorbing agent is corrected by the weight of added water (8 weight %).

The above Examples are to more specifically explain the present invention, and the present invention should not be construed to be limited to the Examples.

This invention, in modifying a water absorbing resin, is capable of giving to the resin a satisfactory surface treatment even at a reaction temperature in the neighborhood of room temperature. The water absorbing agent consequently obtained excels in water absorption properties and, therefore, is industrially useful as evinced by being utilized as for disposable diapers.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An absorbent member for use in absorbent articles, said absorbent member comprising an absorbing agent made by a method comprising the steps of
a) mixing a water absorbing resin, water, and a mixing aid without adding a water-soluble radical polymerization initiator and an ethylenically unsaturated monomer and
b) irradiating the resultant mixture with ultraviolet rays while still agitating the mixture in order to maintain a mixed state.

2. An absorbent member according to claim 1, wherein in said method the amount of the water to be mixed is at least about 1 weight part and is less than about 50 weight parts based on about 100 weight parts of the water absorbing resin.

3. An absorbent member according to claim 1, wherein in said method the mixing aid is at least one compound selected from the group consisting of surfactants, water-soluble polymer, hydrophilic organic solvents, water-soluble inorganic compounds, inorganic acid salts, organic acid salts.

4. An absorbent member according to claim 1, wherein in said method the mixing aid is added in an amount of at least about 0.01 weight parts and less than about 50 weight parts, based on about 100 parts by weight of the water absorbent resin.

5. An absorbent member according to claim 1, wherein in said method the mixing aid is mixed in the form of an aqueous solution with the water absorbing resin.

6. An absorbent member according to claim 5, wherein in said method the aqueous solution has a surface tension of from about 40 dynes/cm to about 75 dynes/cm.

7. An absorbent member according to claim 3, wherein in said method the surfactant is polyoxyethylene alkyl ether.

8. An absorbent member according to claim 3, wherein in said method the surfactant is polyethylene glycol.

9. An absorbent member according to claim 3, wherein in said method the water-soluble inorganic compound is a water-soluble metal salt.

10. An absorbent member according to claim 1, wherein the water absorbing resin contains particles of a particle diameter of at least about 150 μm and less than about 850 μm in a ratio of from about 90 weight % to about 100 weight % of all the particles therein and has a weight average particle diameter (D50) of at least about 300 μm and less than about 500 μm and a logarithmic standard deviation (σζ) of particle distribution of from about 0.20 to about 0.45.

11. An absorbent member according to claim 1, wherein the absorbency of physiological saline against pressure of about 2.07 kPa of the water absorbing agent is at least about 15 g/g and is less than about 50 g/g and is increased by at least about 1 g/g comparing with that of the water absorbing resin.

12. An absorbent member according to claim 1, wherein in said method the water absorbent resin has an acid group and a neutralization degree (mol % of the neutralized acid group in the whole acid group) of from about 50 to about 95 mol %.

13. An absorbent member according to claim 1, wherein the eluted soluble content of the water absorbing agent is at least about 0.1 weight parts and is less than about 30 weight parts, based on about 100 weight parts of the water absorbing resin.

14. An absorbent member according to claim 1, wherein in said method the irradiation with the ultraviolet rays is carried out under increased temperatures.

15. An absorbent member according to claim 1, wherein the water absorbing resin is obtained by polymerizing a monomer having acrylic acid (salt) as a main component thereof.

16. An absorbent member according to claim 1, wherein the water absorbing resin is obtained by preparing a precursor water absorbing resin having a low neutralization ratio and mixing the precursor water absorbing resin with a base.
